(19) United States
(12) Patent Application Publication
(10) Pub. No.: US 2011/0033826 A1
(43) Pub. Date: Feb. 10, 2011

(54) IMPLANT ROOT FOR TOOTH IMPLANTING

(76) Inventor: Chun-Leon CHEN, Changhua City (TW)

Correspondence Address: Guice Patents PLLC, 12647 Galveston Court #302, Manassas, VA, 20112, US

(21) Appl. No.: 12/909,314

(22) Filed: Oct. 21, 2010

Related U.S. Application Data
(62) Division of application No. 12/357,046, filed on Jan. 21, 2009.
Application No. 12/357,046 is a continuation-in-part of application No. 11/564,911, filed on Nov. 30, 2006, now abandoned.

(51) Int. Cl. A61C 8/00

(52) U.S. Cl. 433/174

(57) ABSTRACT

An improved implant root for tooth implanting, a coarse threaded portion of the implant root is formed to have at least two helical treated surfaces extending from the bottom to the top of the implant root of the coarse threaded portion each being treated with a roughened coating (for example, covered with a hydroxyapatite coating) and extending in the whole length of the coarse threaded portion and each extending in the vertical direction. The areas of the roughened coatings can thus be increased in favor of fast growth of a bone of a denture base after implanting into the bone to envelop the implant root; this can shorten the curing process from implanting the implant root to mounting a crown.

This is a continuation in part application of applicant's U.S. patent application Ser. No. 11/564,911.

### BACKGROUND OF THE INVENTION

1. Field of the invention

The present invention relates to an improved implant root for tooth implanting, and especially to an implant root of which a coarse threaded portion is formed to have at least two roughened helical treated surfaces extending from the bottom to the top of the implant root of the coarse threaded portion each extending in the vertical direction, the treated surfaces extend in the whole length of the coarse threaded portion.

2. Description of the Prior Art

The history of the technique of tooth implanting in an oral cavity has been several decades of years; the technique mainly has a tooth on a denture base of a patient pulled out, then an implant root made of metal is implanted into the bone of the denture base of the patient; after the bone grows to envelop the implant root, the tooth implanting work is completed when the implant root is covered with a crown. The advantage of the work is the saving of abrading the true tooth that can solely support and fix the crown. And the false tooth implanted has increased biting force and holding force that reduce inconvenience and discomfort of a patient.

FIG. 1 shows an implant root habitually used presently; basically, the implant root is made of pure titanium or titanium alloy, it has on its upper area a connecting portion 91 to connect with an abutment of the crown, and has on its lower area a sharp threaded portion 92. A horizontal treated surface 93 is provided between the connecting portion 91 and the threaded portion 92; the treated surface 93 is covered with hydroxyapatite similar to the material of human bone with the component of Ca₁₀(PO₄)₆(OH₂), also called as HA coating; the treated surface 93 has a function to combine with a growing bone, so that after implanting of the implant root into a denture base, the implant root can be firmly embedded in the denture base when the growth of the bone is completed, then the crown can be mounted.

With the structure of the implant root, the treated area of the HA coating is small, its ability of helping growth of the bone is inferior, the implant root being implanted is less firm, and improvement is wanted.

Further, a U.S. Pat. No. 5,588,838 disclosed a fixture, for use in a dental implant system of the type having an upper portion with a conically flaring outer surface. The conically flaring outer surface is provided with a circumferentially oriented, defined micro-roughness, preferably in the form of threads or beads, having a height between 0.02 and 0.20 mm, and most preferably approximately 0.1 mm. In the preferred embodiment, the distance between adjacent threads or beads, crest to crest, is approximately twice the height of the threads or beads, respectively. In FIGS. 1 and 2 thereof, it also disclosed that “The cutting edges 4 and the chip-collecting cavities 3 will allow the screw, if necessary, to function as a self-tapping screw for cutting new threads or adjusting already cut threads in the tissue.” However, the sectional areas of the chip-collecting cavities 3 therein are very small, and have not been treated to be roughened, and the space of the tissue of the growing bone is limited, this means that the capability of fixing of the implant root is limited too.

### SUMMARY OF THE INVENTION

The present invention is an improvement on the defect of the conventional implant root structure, wherein a coarse threaded portion of the implant root is formed to have at least two roughened helical treated surfaces each extending in the vertical direction, and the treated surfaces extend in the whole length of the coarse threaded portion; thereby, the area of the roughened helical treated surfaces can be increased in favor of fast growth of a bone to envelop the implant root, by shrinking by volume of the coarse threaded portion, the space for growth of the bone in a denture base thus is increased; by virtue that the growing bone can be combined with the roughened helical treated surfaces extending in the vertical direction, firmness of the implant root implanting into the denture base can be increased, and the time for waiting for mounting the crown can be reduced.

The roughening treating process in the present invention treats with hydroxyapitite coating.

The improved implant root provided in the present invention can have the cutting force for implanting the implant root increased during implanting of the implant root into the denture base by extending in the vertical direction of helical treated surfaces of the coarse threaded portion, and the bone dusts in the denture base will stay in the treated surfaces, thereby the implant root can be smoothly inserted in the bone.

The cut faces on the helical treated surfaces of the improved implant root provided in the present invention can be plane or recessed arciform surfaces or helical surfaces; this further increases the areas of the treated surfaces and the space for staying of the bone dusts.

According to the present invention, the helical treated surfaces can be two or three surfaces laid out in an equiangularly spaced away mode, all the surfaces extend in the vertical direction as the implant root does.

The present invention will be apparent in its structure and its way of using after reading the detailed description of the preferred embodiment thereof in reference to the accompanying drawings.

### BRIEF DESCRIPTION OF THE DRAWINGS

FIG. 1 is a perspective view showing the appearance of a conventional implant root;

FIG. 2 is a perspective view showing the appearance of the first embodiment of the present invention;

FIG. 3 is a sectional view taken from an A-A sectional line in FIG. 2;

FIG. 4 is a perspective view showing the appearance of the second embodiment of the present invention;

FIG. 5 is a sectional view taken from a B-B sectional line in FIG. 4; and

FIG. 6 is a sectional view taken from FIG. 2 showing its front side of the second preferred embodiment of the present invention with an abutment connected;

FIG. 7 is an exploded perspective view from FIG. 2;

FIG. 8 is a perspective view showing the appearance of the third embodiment of the present invention;

FIG. 9 is a sectional view taken from an A-A sectional line in FIG. 8;

FIG. 10 is a schematic sectional view showing implanting of an implant root of the present invention.

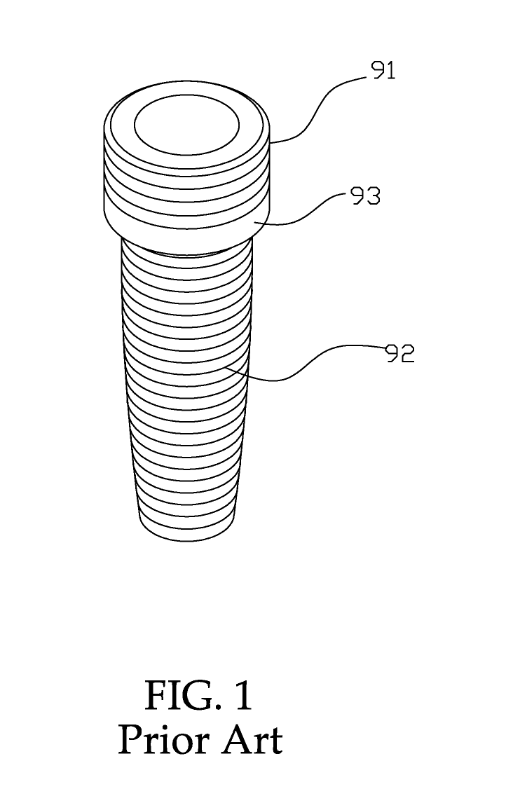

### DETAILED DESCRIPTION OF THE PREFERRED EMBODIMENT

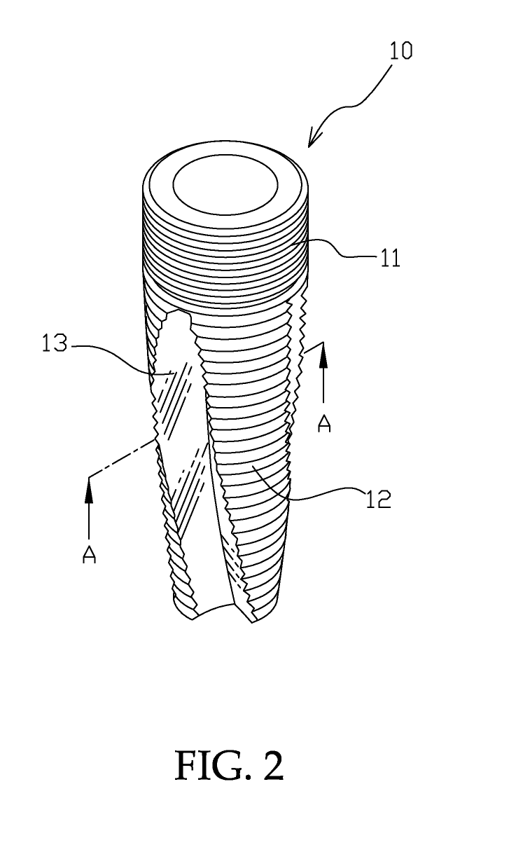

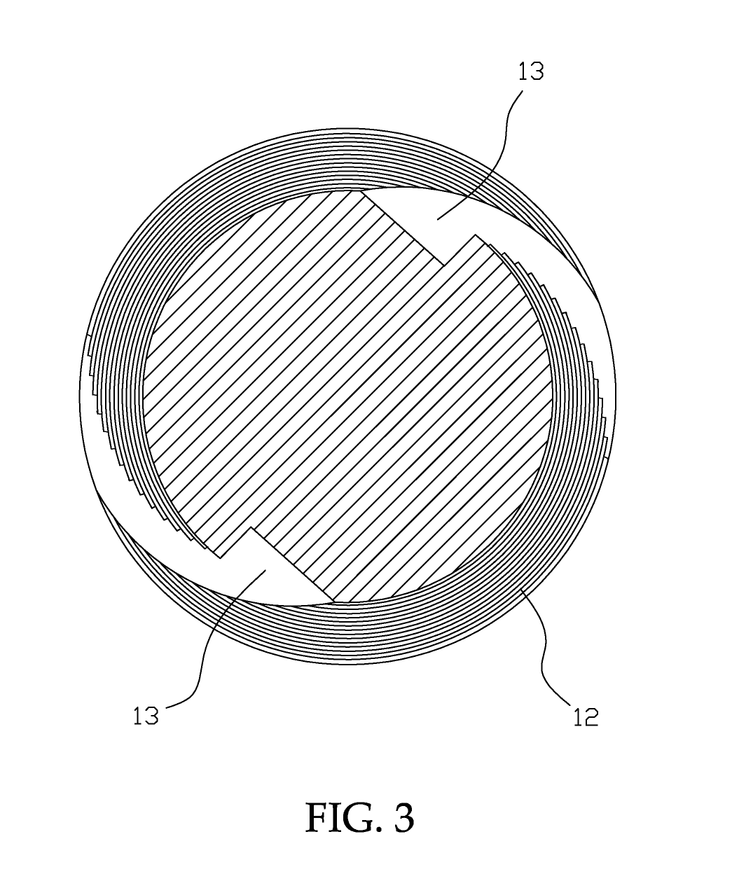

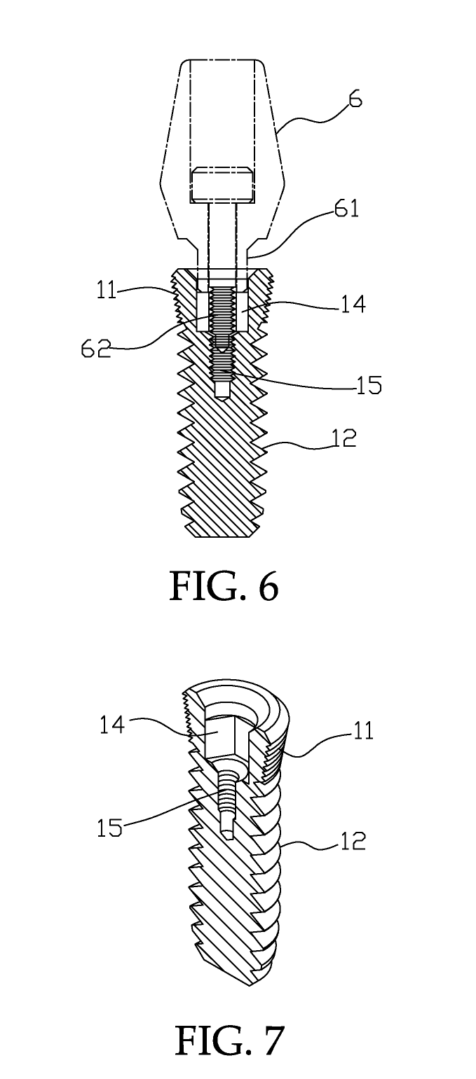

Referring to FIGS. 2 and 3 showing the first embodiment of the present invention, wherein an implant root 10 has on its upper area a connecting portion 11, the connecting portion 11 has on its outer surface a fine threaded portion, and the implant root 10 has on its lower area a coarse threaded portion 12. The connecting portion 11 is connected with an abutment 6 of a crown such as is shown in FIG. 6; the surfaces of the coarse threaded portion 12 have sharp threads that can be implanted in a denture base of a patient by rotation.

Two helical treated surfaces 13 (on which cut faces are plane surfaces) formed on the coarse threaded portion 12 extending in the vertical direction are treated with roughened coatings, for example, covered with hydroxyapatite coatings, and the helical treated surfaces 13 extend in the whole length of the coarse threaded portion. Thereby the areas of the roughened helical treated surfaces 13 are larger than the area of the conventional horizontal treated surface 93, and thereby the bone of the denture base can get fast growth to envelop the implant root 10; further by combining of the roughened helical treated surfaces 13 extending in the vertical direction, firmness of the implant root 10 implanting into the denture base can be increased, and the time for waiting for mounting the crown can be reduced. And further, by extending in the vertical direction of the helical treated surfaces 13 of the coarse threaded portion 12, during implanting the implant root 10 in the denture base, the bone dusts in the denture base will stay in the helical treated surfaces 13, thereby the implant root 10 can be smoothly inserted in the bone.

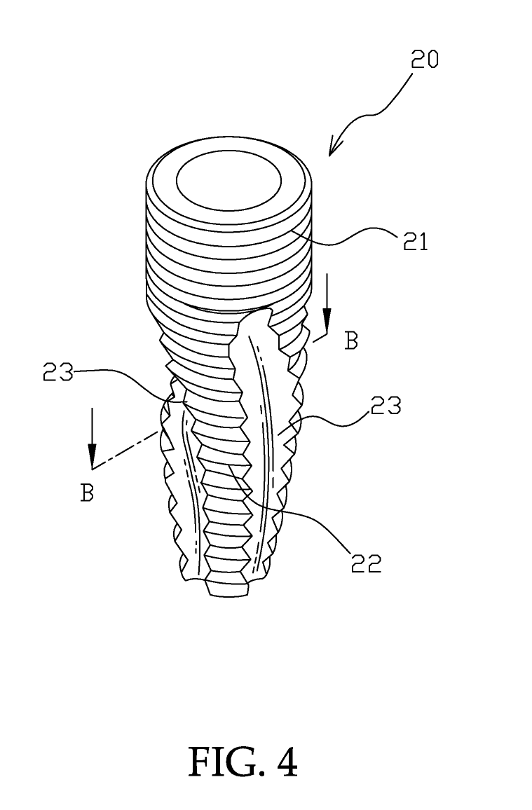

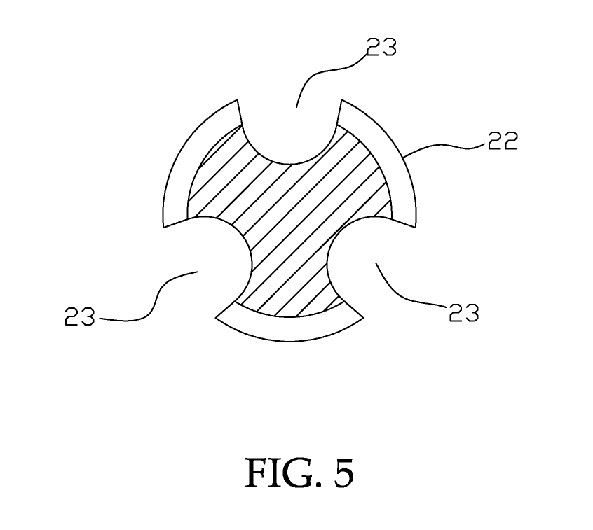

Referring to FIGS. 4 and 5 showing the second embodiment of the present invention, wherein an implant root 20 has a connecting portion 21, the connecting portion 21 has on its outer surface a fine threaded portion, and the implant root 20 has on its lower area a coarse threaded portion 22. The coarse threaded portion 22 has three helical treated surfaces 23 laid out in an equiangularly spaced away mode and all extending in the vertical direction and are treated with HA coatings, cut faces on the three helical treated surfaces 23 are recessed arciform surfaces (referring to FIG. 5) to further increase the areas of the treated surfaces and the space for staying of the bone dusts.

Referring to FIGS. 6 and 7, the connecting portion 11 is provided with a polygonal hole 14, a screw hole 15 is provided in the bottom surface of the polygonal hole 14. Wherein the polygonal shape of the polygonal hole 14 is mated with the shape of a connecting section 61 of the abutment 6, so that the abutment 6 can be fast and correctly positioned when in connecting with the implant root 10, and a bolt 62 on the bottom of the abutment 6 can be smoothly rotated to connect into the screw hole 15 of the implant root 10, and thus connection is completed. If incorrect positioning is resulted, the bolt 62 will be too short to be locked in the screw hole 15; thereby the situation of incorrect positioning can be completely prevented.

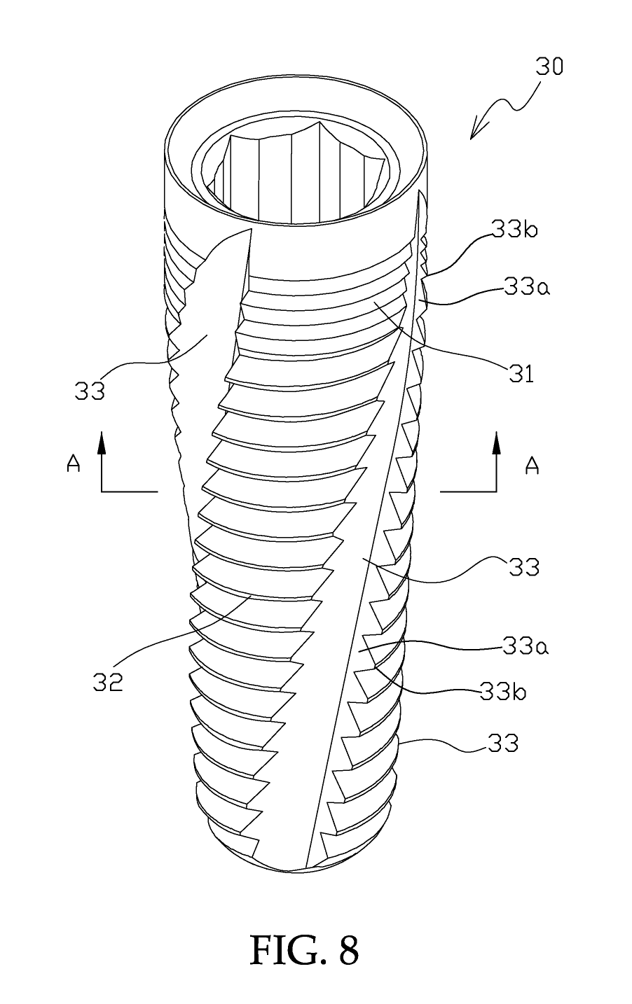

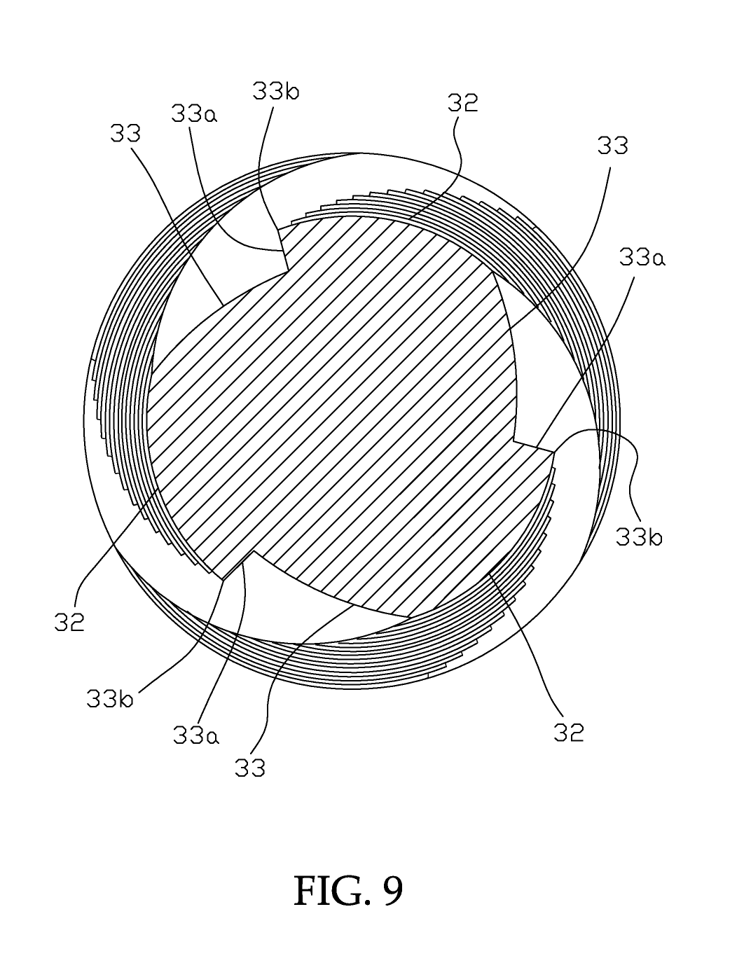

Referring to FIGS. 8 and 9 showing the third embodiment of the present invention, wherein an implant root 30 has a connecting portion 31, the connecting portion 31 has on its outer surface a fine threaded portion, and the implant root 30 has on its lower area a coarse threaded portion 32. The coarse threaded portion 32 has three helical treated surfaces 33 laid out in an equiangularly spaced away mode. The three helical treated surfaces 33 on which cut faces are helical surfaces (referring to FIG. 9) all extend from bottom to top in the vertical direction on the coarse threaded portion 32, and in the whole length of the coarse threaded portion 32 till the fine threaded portion of the connecting portion 31, and are cut inwardly gradually shallower from bottom to top in order to avoid being cut into the central positioning hole.

Referring to FIG. 9, the helical treated surfaces 33 are treated with roughened coatings; wherein each of many cut faces 33a on the helical treated surfaces 33 at corresponding threads forms a sharp blade 33b at an intercrossing area with the thread of the coarse threaded portion 32 or of the fine threaded portion of the connecting portion 31, this may extremely benefit to the effect of fast tooth implanting during implanting into the bone of a denture base of a patient by having the function of easily cutting in the bone.

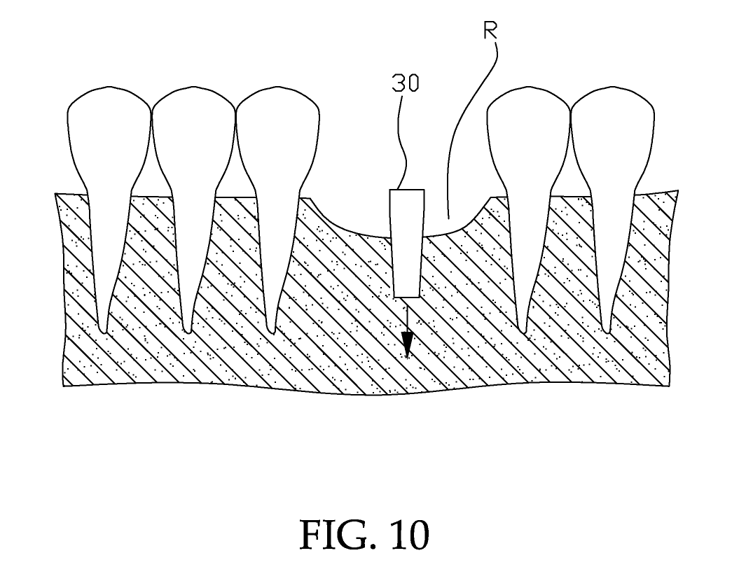

And referring to FIG. 10, it shows that in fast tooth implanting, an implant root 30 is directly implanted into a recess (R) on the denture base; by virtue that the coarse threaded portion 32 or of the fine threaded portion of the connecting portion 31 has the sharp blade 33b, it can easily cut in the bone to make the implant root 30 be correctly implanted vertically.

In conclusion, according to the description disclosed above, the improved implant root provided by the present invention has the novelty and improvement that a patent should have. And the embodiments given are only for illustrating the present invention; it will be apparent to those skilled in this art that various equivalent modifications or changes without departing from the spirit of this invention, such as increasing or shape changing of the treated surfaces, shall also fall within the scope of the appended claims.

1. An improved implant root for tooth implanting into a bone of a denture base of a patient, said implant root comprises:
a connecting portion having on its outer surface a fine threaded portion connected with an abutment of a crown;
a coarse threaded portion on a lower area below said connecting portion, surfaces of said coarse threaded portion have sharp threads;
at least two helical treated surfaces formed on said coarse threaded portion and extending in a vertical direction from a bottom end to a top end of said coarse threaded portion and extending in whole length of said coarse threaded portion, said treated surfaces are treated with roughened coatings.

2-3. (canceled)

4. The improved implant root for tooth implanting as claimed in claim 1, wherein cut faces on said at least two helical treated surfaces are helical surfaces.

5. (canceled)

6. The improved implant root for tooth implanting as claimed in claim 1, wherein said at least two helical treated surfaces are more than three helical treated surfaces laid out in an equiangularly spaced away mode, said helical treated surfaces are formed on said coarse threaded portion and extending in said vertical direction from said bottom end to said top end of said coarse threaded portion and extending in whole length of said coarse threaded portion till a fine threaded portion of said connecting portion, and are cut inwardly gradually shallower from bottom to top.

7. The improved implant root for tooth implanting as claimed in claim 6, wherein each of many cut faces on said at least two helical treated surfaces at corresponding one of said threads forms a sharp blade at an intercrossing area with said thread of said coarse threaded portion or of said fine threaded portion.
